(19) United States
(12) Patent Application Publication
(10) Pub. No.: US 2015/0139273 A1
(43) Pub. Date: May 21, 2015

(54) METHOD AND APPARATUS FOR MEASURING EMISSIVITY AND DENSITY OF CRUDE OIL

(71) Applicant: AKER SUBSEA LIMITED, Maidenhead, Berkshire (GB)

(72) Inventors: Philip Michael Bagley, Maidenhead (GB); Robin Slater, Maidenhead (GB)

(21) Appl. No.: 14/404,160

(22) PCT Filed: May 15, 2013
(86) PCT No.: PCT/GB2013/000217

§ 371 Date: Nov. 26, 2014

(30) Foreign Application Priority Data
May 26, 2012 (GB) 1209380.3

(51) Int. Cl. G01J 5/10

(52) U.S. Cl. CPC G01J 5/10
USPC 374/129

(57) ABSTRACT

Apparatus for use in the measurement of the API gravity of crude oil, comprises a conduit (1)for the oil, a thermo-couple (4) in the conduit for measuring temperature of the oil in contact therewith, a sapphire window (3) in the conduit, an infrared thermometer (5,6) for the measurement of the temperature of the oil through the window, and means (20) for comparing the measurements of temperature made by the thermometers to obtain a measure of the emissivity of the crude oil and thereby its API gravity.

### FIELD OF THE INVENTION

This invention relates to the measurement of density and particularly the API gravity of crude oil.

### BACKGROUND TO THE INVENTION

The American Petroleum Institute gravity, or API gravity, is a measure of how heavy or light petroleum liquid is compared to water. It is related to specific gravity (SG) by the linear relationship API gravity=141.5/(SG)−131.5, so that if the liquid's API gravity is greater than 10, the liquid is lighter than and floats on water; if the liquid's API gravity is less than 10, the liquid is heavier than water and sinks.

API gravity is used to compare the relative densities of petroleum liquids. Its definition is density at a temperature of 15.6° C. The higher the API gravity is, the lighter the crude oil. ‘Light crude’ oil generally has an API gravity of 38 degrees or more, and ‘heavy crude’ oil has an API gravity of 22 degrees or less. Crude oil with an API gravity between 22 and 38 degrees is generally called ‘medium crude’. Crude oil is also characterised in terms of sulphur content. ‘Sweet’ crude is commonly defined as oil with a sulphur content of less than 0.5%, whereas ‘sour’ crude has a sulphur content of greater than 0.5%.

The quality of crude oil dictates the level of processing and conversion necessary to achieve what a refiner sees as an optimal mix of products. Light, sweet crude is more expensive than heavier, sourer crude because it requires less processing than heavier sourer crude oil for the production of a given final petroleum product.

Therefore, an online remote method for measuring API gravity would be of use to the oil industry.

All objects emit infrared radiation above absolute zero according to the black body radiation law. Remote detection of temperature of an object requires a knowledge of the emissivity of that object. Emissivity is a term representing a material's ability to emit thermal radiation. Each material has a different emissivity. A material's emissivity can range from a theoretical zero (completely not-emitting) to an equally-theoretical unity (completely emitting); the emissivity often varies with temperature. A black body is a theoretical object which will radiate infrared radiation at its contact temperature. If a thermocouple on a black body radiator reads 50° C., the radiation the black body will give up will also be 50° C. Therefore a true black body will have an emissivity of unity.

The present invention relies on the fact that emissivity of crude oil is related to its API Gravity. Provided that the measurement of emissivity is sufficiently accurate, it should provide a reasonable indication of the crude oil's API Gravity. The variation of emissivity of crude oil with API Gravity enables according to the invention detection of API Gravity change by comparing different methods of crude oil temperature measurement.

In a preferred embodiment of the invention a contact thermometer, such as a highly accurate thermocouple temperature sensor, measures the actual temperature of the crude oil. A second, remote, infrared sensor may be calibrated using the same crude oil sample with an appropriate emissivity to measure an identical temperature. As crude oil flows past both sensors any difference in temperature measurement of the remote infrared sensor (beyond calibration drift and accuracy limits) to the thermocouple sensor indicates a change in emissivity of the crude oil and hence an API Gravity change.

### BRIEF DESCRIPTION OF THE DRAWINGS

FIG. 1 is a schematic drawing of a differential temperature measurement

FIG. 2 is a schematic representation of the measuring system.

FIG. 3 is a schematic diagram of a calibration and measurement method according to the invention.

### DETAILED DESCRIPTION

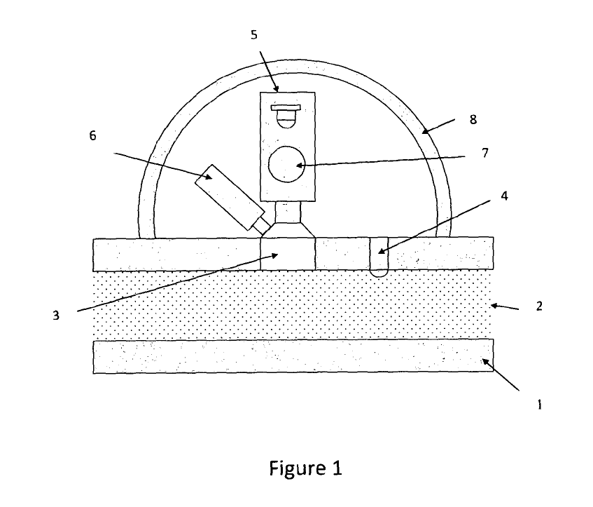

FIG. 1 is a schematic drawing of a differential temperature measurement device for the estimation of crude oil density. At a suitable location on a conduit 1 such as a flow line (or in a downhole measurement device) through which crude oil 2 can flow is a window 3 positioned so that an optical measurement can be taken of the crude oil within the flow line.

In close proximity to the window 3 a contact thermometer 4 (e.g. a thermocouple) is also mounted such that its sensing element is in contact with the crude oil. An infrared thermometer is positioned such that the crude oil temperature can be detected through the window 3. The infra-red thermometer may be a transmitter and receiver in one device, or alternatively can be arranged (as shown) as a transmitter 5 with a receiver 6 in a second device, both observing the crude oil through the sapphire window. The infra-red emission from the infrared thermometer can be focused on the crude oil using a lens 7, which may be made of germanium. The infra-red thermometer is disposed in a housing 8 adjacent the conduit 1 and covering the window 3.

The window 3 is preferably made of sapphire glass, which has several beneficial properties for a window for this application. Sapphire glass is a single crystal of aluminium oxide (Al₂O₃). It is mechanically very robust with high tensile strength (400 MPa) and high modulus of elasticity (345 GPa) making it extremely resistant to abrasion and impact. It is thermally stable, its mechanical and optical properties not altering to temperatures exceeding 2000° C. It has superior transmission properties with transmission windows from 190 nm to 5000 nm (1 mm thickness), making it suitable for both near ultraviolet fluorescence stimulation and infra-red applications.

Infra-red radiation is electromagnetic radiation with a wavelength longer than visible light in a band approximately from 780 nm to 300 um (depending on classification). A sapphire window with a transmission window from 190 nm to approximately 5 um is only suitable to pass infrared radiation in the near infrared band (780 nm to 3 um) and some of the mid infrared band (3 um to 50 um). A germanium window would provide the best option for transmission of infrared wavelengths. However the mechanical properties of currently available germanium windows are not ideal for use in a flowline.

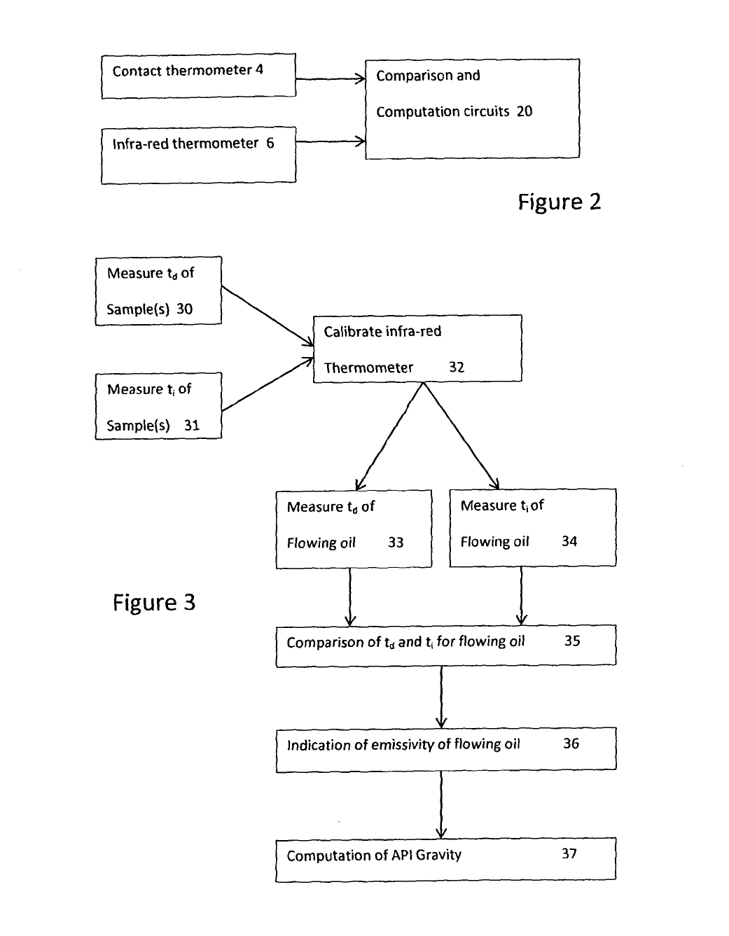

FIG. 2 illustrates in simplified form a system according to the invention. The measurements of temperature by the contact thermometer 4 and the infra-red thermometer 5 & 6 are compared in comparison and computation circuits 20 which are programmed in accordance with (for example) tables relating emissivity to API gravity. The comparison and computation circuits may be within the instrument housing. Alternatively signals representing the measurements can be transmitted for example by cable to a remote location for processing.

FIG. 3 illustrates schematically a method of calibration and measurement according to the invention.

Stages 30, 31 and 32 in FIG. 3 indicate the calibration of at least the infra-red thermometer. One may choose a known sample of crude oil to calibrate both the contact and infra-red thermometers. This oil sample will be some standard and done before deployment of the system subsea. Suppose this calibration sample has an API gravity of at 15.6 degrees C. This temperature is convenient to use because it is the temperature at which API gravity is defined. Using this sample the temperature t_{d} indicated by the contact thermometer (after calibration if that be necessary) is 15.6° C. and the infrared thermometer is calibrated so that its temperature reading tᵢ is likewise 15.6° C. In practice the infrared thermometer may have a scaling factor that compensates for the emissivity of the sample which it views.

Stages 33 and 34 in FIG. 3 indicate the measurement of temperature of crude oil flowing in the conduit i.e. the flowline 1 by means of the contact and infra-red thermometers. The crude oil passing both thermometers will have varying density. If the density of the crude oil is different from an API of 30 then the emissivity of that crude oil sample will be different from the emissivity of the calibrated sample. However, the infrared thermometer is measuring the temperature on the assumption that the difference d between t_{d} and tᵢ is the same as it was in the calibrated sample. So the infrared radiation from the crude oil will be different from the calibrated infrared radiation level. Accordingly the temperature tᵢ measured by the infra-red thermometer will be different from the temperature td measured by the contact thermometer. This difference is detected (stage 35) and is related to the emissivity of the crude oil and hence the API gravity of the oil. A value for the emissivity is obtained (stage 36) and converted to a value for the API gravity (stage 37).

Research shows that changes in emissivity with density are small for typical crude oil samples and ranges, so the thermometers will have to be very accurate and very stable.

1. Apparatus for use in the measurement of the API gravity of crude oil, comprising a conduit for the oil, a thermometer in the conduit for measuring the temperature of the oil in contact therewith, a window in the conduit, an infrared thermometer for the measurement of the temperature of the oil through the window, and means for comparing the measurements of temperature made by the thermometers, where the means is organised to detect a change in emissivity of the crude oil.

2. (canceled)

3. Apparatus according to claim 1 in which the window comprises sapphire glass.

4. Apparatus according to claim 1 in which the contact thermometer is disposed in the conduit and adjacent the window.

5. Apparatus according to claim 1 in which the contact thermometer comprises a thermocouple.

6. Apparatus according to claim 1 in which the conduit is a flowline.

7. A method of measuring the emissivity of crude oil, comprising:
measuring the temperature of at least one sample of crude oil with a contact thermometer;
measuring the temperature of the sample with an infra-red thermometer which is disposed to detect the temperature of the sample through a window;
calibrating the infra-red thermometer to indicate the same temperature for said sample as does the contact thermometer;
measuring the temperature of flowing crude oil with the contact thermometer;
measuring through said window the temperature of said flowing crude oil with the infra-red thermometer; and
comparing the temperatures of the flowing crude oil as measured by the contact thermometer and the infra-red thermometer to obtain an indication of the emissivity of the flowing crude oil.

8. A method of measuring the API gravity of flowing crude oil by means of measuring the emissivity of the crude oil and converting the measured emissivity into a measure of API gravity.
